(19) United States
(12) Patent Application Publication
(10) Pub. No.: US 2005/0091929 A1
(43) Pub. Date: May 5, 2005

(54) Module for incorporation into a door

(76) Inventor: Kazuma Shibata, Kosai-shi (JP)

Correspondence Address: Marsh Fischmann & Breyfogle LLP, 3151 South Vaughn Way, Suite 411, Aurora, CO, 80014, US

(21) Appl. No.: 10/977,040

(22) Filed: Oct. 29, 2004

(30) Foreign Application Priority Data
Oct. 30, 2003 (JP) 2003-371069

(51) Int. Cl. E05F 11/44

(52) U.S. Cl. 49/350

(57) ABSTRACT

A module for incorporation into a door includes a base panel made of resin, a window motor attached to the base panel, a pinion gear, which is rotated by operation of the window motor, a carrier for retaining a window glass, and a power transmission arm, which is rotatably supported by the base panel. The power transmission arm includes a gear portion, which is engaged with the pinion gear, an arm portion, which has a distal end to be coupled to the carrier, and a coupler, which couples the gear portion to the arm portion. The coupler is formed of resin material having the same coefficient of linear expansion as the base panel. As a result, the engagement between the pinion gear and the gear portion is always reliably maintained regardless of temperature change.

### BACKGROUND OF THE INVENTION

The present invention relates to a module, which is incorporated in, for example, a door of a vehicle.

Such a door incorporated module is generally located in a gap between an outer panel and a door trim of a door of a vehicle. The door incorporated module is formed by attaching a window motor and a window regulator to a base panel made of resin. In the prior art, a sector type window regulator has been proposed. As a sector type window regulator, an X-arm type window regulator disclosed in Japanese National Phase Laid-Open Publication No. 12-510074 and a single-arm type window regulator disclosed in Japanese Laid-Open Patent Publications No. 6-146708 and No. 2000-27531 have been proposed. Since the single-arm type window regulator has fewer parts and less weight as compared to the X-arm type window regulator, the single-arm type window regulator mechanism is becoming widely used.

A door incorporated module, which is equipped with the single-arm type window regulator, includes a metal arm rotatably attached to a base panel made of resin. A window motor is attached to the base panel, and a gear rotated by the motor meshes with gear teeth formed at one end of the arm. The arm is rotated in accordance with the actuation of the window motor, which moves a window vertically. The coefficient of linear expansion of the material forming the base panel differs by a large amount from the coefficient of linear expansion of the material forming the arm. Therefore, the relative position between the base panel and the arm varies in accordance with the expansion and contraction due to the temperature change. The variation in the relative position deteriorates the engagement between the gear of the window motor and the gear teeth of the arm, which causes problems such as generation of an abnormal noise.

### SUMMARY OF THE INVENTION

Accordingly, it is an objective of the present invention to provide a module for incorporation into a door that suppresses occurrence of problems due to temperature change.

To achieve the above objective, the present invention provides a module for incorporation into a door for moving a window glass provided with the door. The module includes a base panel made of resin, a window motor attached to the base panel, a gear, which is rotated by operation of the window motor, a carrier for retaining the window glass, and a power transmission arm, which is supported by the base panel to be rotatable about a predetermined rotational axis. The power transmission arm has a first end, which is engaged with the gear, and a second end, which is coupled to the carrier. When the gear is rotated by the window motor, the power transmission arm is rotated about the rotational axis. The rotation of the power transmission arm moves the window glass. The power transmission arm has a portion made of material having a coefficient of linear expansion that is substantially the same as or greater than the coefficient of linear expansion of the base panel between the first end and the rotational axis.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a front view illustrating a door incorporated module according to a first embodiment of the present invention;

FIG. 1(b) is a cross-sectional view taken along line 1b-1b of FIG. 1(a);

FIG. 2 is a partial cross-sectional view illustrating the door incorporated module of FIG. 1(a) as viewed from the bottom;

FIG. 3 is an enlarged partial view of FIG. 2;

FIG. 4(a) is a side view illustrating a carrier;

FIG. 4(b) is a rear view illustrating the carrier;

FIG. 5 is a view illustrating the carrier sliding with respect to a power transmission arm;

FIG. 6(a) is an enlarged partial view illustrating the door incorporated module of FIG. 1(a);

FIG. 6(b) is a cross-sectional view taken along line 6b-6b of FIG. 6(a);

FIG. 7(a) and 7(b) are explanatory views showing the movement of the power transmission arm;

FIG. 8(a) is a cross-sectional view illustrating a base panel;

FIG. 8(b) is a cross-sectional view illustrating the power transmission arm;

FIG. 9 is a front view illustrating a door incorporated module according to a second embodiment of the present invention;

FIG. 10(a) is an enlarged partial view illustrating the door incorporated module of FIG. 9; and

FIG. 10(b) is a cross-sectional view taken along line 10b-10b of FIG. 10(a).

### DETAILED DESCRIPTION OF THE PREFERRED EMBODIMENTS

A first embodiment of the present invention will now be described with reference to the drawings.

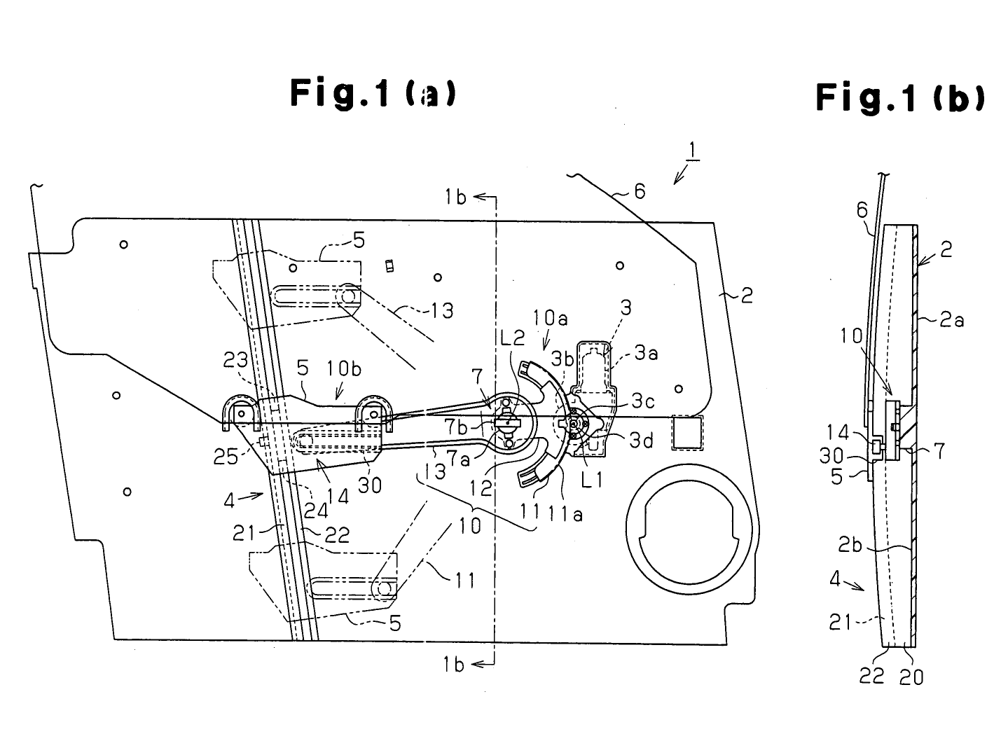

A door incorporated module 1 shown in FIG. 1(a) is incorporated in a door of a vehicle. As shown in FIG. 1, the door incorporated module 1 has a base panel 2 made of resin. A window motor 3 is attached to the base panel 2, which is provided with a guide rail 4. A carrier 5, which retains a window glass 6, is located on the guide rail 4. Power for the window motor 3 is transmitted to the carrier 5 via a power transmission arm 10. Accordingly, the carrier 5 moves along the guide rail 4 while retaining the window glass 6.

As shown in FIG. 1(a), the base panel 2 is located toward the inside of the vehicle passenger compartment from an outer panel of a vehicle door, and more specifically, between the outer panel and a door trim. The base panel 2 is substantially a parallelogram as viewed from the side of the vehicle and has a plate-like form. In FIG. 1(b), the right surface of the base panel 2 is a first surface 2a facing the interior of the vehicle passenger compartment and the left surface of the base panel 2 is a second surface 2b facing the exterior of the vehicle passenger compartment. The window motor 3 is attached to the first surface 2a. The window motor 3 includes a motor main body 3a and a gear mechanism 3b, which is coupled to the motor main body 3a.

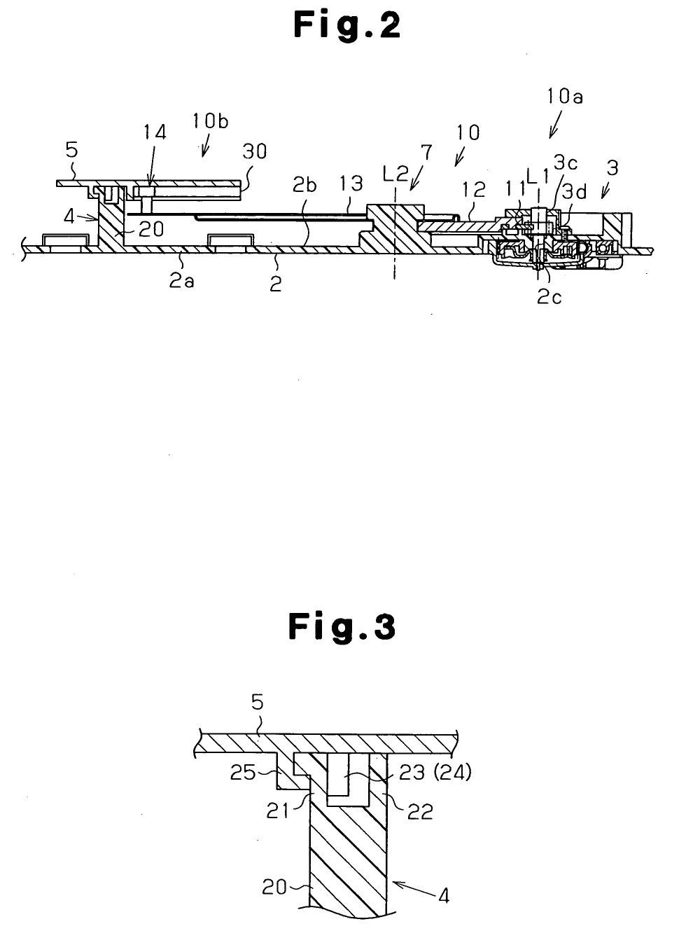

As shown in FIG. 2, an output shaft 3c from the gear mechanism 3b extends through an insertion hole 2c formed in the base panel 2 and projects from the second surface 2b. A pinion gear 3d is secured to the distal end of the output shaft 3c and rotates integrally with the output shaft 3c about the axis L1. The pinion gear 3d corresponds to the gear rotated by the window motor 3. The pinion gear 3d is meshed with a first end 10a of the power transmission arm 10. The power transmission arm 10 will be described later.

As shown in FIGS. 1(a) and 1(b), a guide member, which is the guide rail 4 in the first embodiment, extends on the second surface 2b of the base panel 2 along the direction in which the window glass 6 moves. In the first embodiment, the guide rail 4 is integrally formed with the base panel 2. The guide rail 4 is located further rearward (leftward as viewed in FIG. 1(a)) of the vehicle than an arm support portion 7, which rotatably supports the power transmission arm 10. The guide rail 4 is straight as viewed from a direction perpendicular to the second surface 2b of the base panel 2 as shown in FIG. 1(a). On the other hand, when viewing from the direction parallel to the second surface 2b as shown in FIG. 1(b), the vertex of the guide rail 4 curves outward such that the longitudinal center of the guide rail 4 projects from the second surface 2b by the greatest amount. The curvature of the vertex of the guide rail 4 is the same as the curvature of the window glass 6.

As shown in FIGS. 2 and 3, the guide rail 4 includes a base portion 20, which projects from the second surface 2b of the base panel 2, and a guide portion 21 and a support portion 22, which are integrally formed with the vertex of the base portion 20. The guide portion 21 has an L-shaped cross-section and the support portion 22 has a rectangular cross-section.

As shown in FIG. 1(b), the vertex of the base portion 20 curves in accordance with the curvature of the window glass 6. The base portion 20 has a predetermined width in the front and rear direction of the vehicle (left and right direction as viewed in FIG. 1(a)). The guide portion 21 is located rearward of the support portion 22 in the width direction of the base portion 20. The guide portion 21 and the support portion 22 extend along the longitudinal direction of the base portion 20. The guide portion 21 and the support portion 22 have a constant cross-section in the longitudinal direction. The vertex of the guide portion 21 and the vertex of the support portion 22 curve in accordance with the curvature of the window glass 6. The cross-section of the base portion 20 may be constant in the longitudinal direction. In this case, the projecting heights of the guide portion 21 and the support portion 22 are changed such that the vertex of the guide portion 21 and the vertex of the support portion 22 curve in accordance with the curvature of the window glass 6.

As shown in FIG. 1(a), the window glass 6 is secured to the carrier 5 at two portions so that the window glass 6 does not rotate with respect to the carrier 5. The carrier 5 is coupled to a second end 10b of the power transmission arm 10.

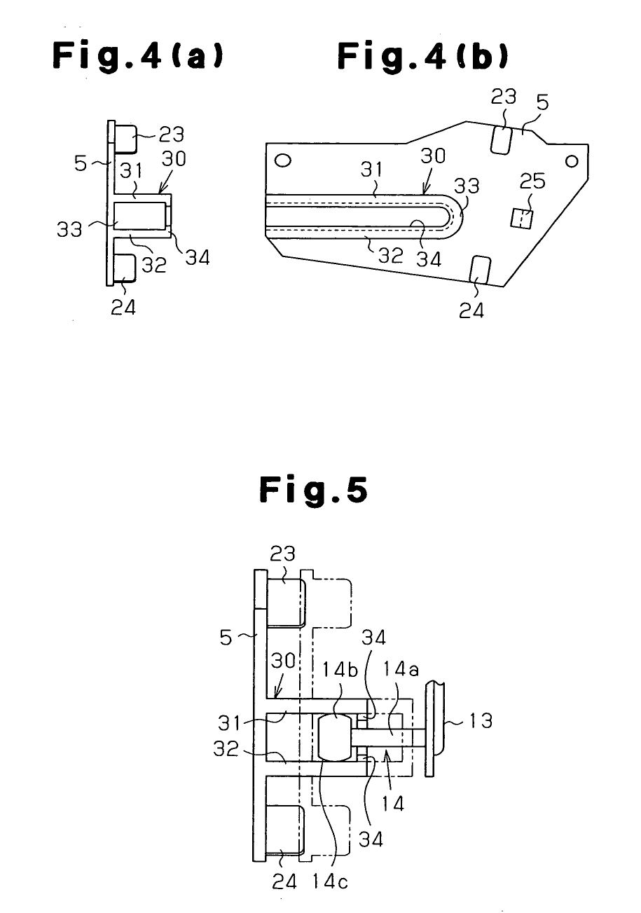

As shown in FIGS. 3, 4(a), and 4(b), the carrier 5 includes a first guided portion 23 and a second guided portion 24, which have rectangular cross-sections, and a third guided portion 25, which has an L-shaped cross-section, provided on the surface facing the guide rail 4. As shown in FIG. 1(a), the first guided portion 23 is located above the second guided portion 24 and the third guided portion 25 is located between the first guided portion 23 and the second guided portion 24 in the vertical direction.

As show in FIG. 3, the first and second guided portions 23, 24 are located in a groove between the guide portion 21 and the support portion 22 and contact the guide portion 21. The third guided portion 25 cooperates with the first and second guided portions 23, 24 to sandwich the guide portion 21 and contacts the guide portion 21. The vertex of the guide portion 21 and the distal end of the third guided portion 25 are bent to be engaged with each other. The bent vertex of the guide portion 21 is inserted between the third guided portion 25 and the carrier 5. Therefore, the first to third guided portions 23, 24, and 25 hold the guide portion 21 such that they do not disengage from the guide portion 21. The vertex of the support portion 22 contacts the carrier 5 and prevents the carrier 5 from being tilted with respect to the guide rail 4.

As shown in FIG. 2, the carrier 5 is located closer to the outer surface of the vehicle door than the power transmission arm 10 (upward as viewed in FIG. 2). As shown in FIGS. 2 and 5, an engaging rail 30 is located on the surface of the carrier 5 facing the base panel 2. The engaging rail 30 is located further forward in the vehicle (rightward as viewed in FIG. 1(a)) from the first to third guided portions 23 to 25.

As shown in FIG. 4(b), the engaging rail 30 is substantially U-shaped. As shown in FIGS. 4(a), 4(b), and 5, the engaging rail 30 includes a first rail portion 31, a second rail portion 32, a coupling portion 33, and an engaging portion 34. The first rail portion 31 and the second rail portion 32 are located on the carrier 5 at a predetermined distance from each other and extend parallel to each other along the front and rear direction of the vehicle (left and right direction as viewed in FIG. 4(b)). The coupling portion 33 connects one end of the first rail portion 31 to one end of the second rail portion 32. The engaging portion 34 extends along the upper rim of the first and second rail portions 31, 32 and the coupling portion 33 to form a U-shape. The engaging portion 34 forms a gap that is smaller than the gap between the first and second rail portions 31, 32 between the upper rims of the first and second rail portions 31, 32.

As shown in FIG. 1(a), the power transmission arm 10 is rotatable about the arm support portion 7, which projects from the second surface 2b of the base panel 2. The power transmission arm 10 includes a gear portion 11, a coupler 12, and an arm portion 13. The gear portion 11 is located at the first end 10a of the power transmission arm 10 and is engaged with the pinion gear 3d. The second end 10b of the power transmission arm 10, that is, the distal end of the arm portion 13 is coupled to the carrier 5. The arm support portion 7 includes a substantially columnar support shaft 7a, which projects from the base panel 2, and a locking portion 7b formed at the distal end of the support shaft 7a. The support shaft 7a rotatably supports the power transmission arm 10 and the locking portion 7b locks the power transmission arm 10 to the base panel 2.

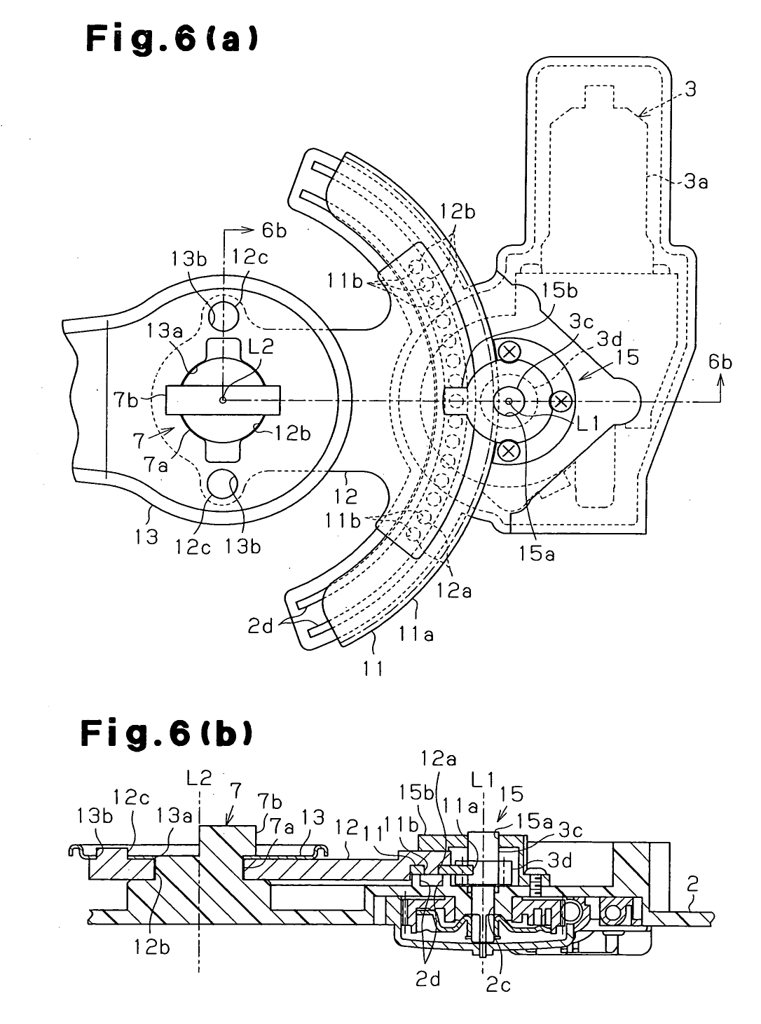

The gear portion 11 is made of metal and is a plate material substantially arcuate about the axis L2 of the arm support portion 7 as shown in FIG. 6(a). A meshing portion 11a, which engages with the pinion gear 3d, is formed on the outer circumferential surface of the gear portion 11. Rotation of the pinion gear 3d is transmitted to the gear portion 11 and rotates the power transmission arm 10. The gear portion 11 has engaging holes 11b arranged along the arcuate shape of the gear portion 11.

The coupler 12 is formed of resin having the same coefficient of linear expansion as resin forming the base panel 2. As shown in FIG. 6(a), the proximal end of the coupler 12 is rotatably supported by the arm support portion 7 and the distal end of the coupler 12 is coupled to the gear portion 11. The distal end of the coupler 12 is arcuate corresponding to the gear portion 11 and has first projections 12a that correspond to the engaging holes 11b. As shown in FIG. 6(b), each first projection 12a is inserted into one of the engaging holes 11b. The proximal end of the coupler 12 has an opening portion 12b, the diameter of which is the same as that of the support shaft 7a of the arm support portion 7. The support shaft 7a is inserted in the opening portion 12b. The opening portion 12b has a pair of recesses that permit the locking portion 7b of the arm support portion 7 to pass therethrough when the coupler 12 is rotated by 90 degrees from the state shown in FIG. 6(a). Two second projections 12c are formed at the proximal end of the coupler 12 to sandwich the opening portion 12b.

As shown in FIGS. 6(a) and 6(b), a pair of support projections 2d extend on the base panel 2 along the arcuate shape of the gear portion 11 on both sides of the line of the engaging holes 11b. The support projections 2d are integrally formed with the base panel 2. The gear portion 11 rotates while sliding along the support projections 2d. As shown in FIG. 6(b), a retaining member 15, which is secured to the base panel 2, retains the gear portion 11 and the coupler 12 piled on top of the support projections 2d. The retaining member 15 has an insertion hole 15a, in which the output shaft 3c is inserted. The retaining member 15 also has a retaining piece 15b. The gear portion 11 and the coupler 12 are sandwiched between the retaining piece 15b and the support projections 2d. The retaining member 15 is formed to permit the gear portion 11 to rotate about the arm support portion 7.

The arm portion 13 is made of long metal plate. The proximal end of the arm portion 13 is coupled to the coupler 12 and is rotatably supported by the arm support portion 7. The distal end of the arm portion 13 is coupled to the carrier 5. An opening portion 13a and a pair of engaging holes 13b are formed at the proximal end of the arm portion 13. The opening portion 13a has substantially the same shape as the opening portion 12b of the coupler 12. The support shaft 7a of the arm support portion 7 is inserted in the opening portion 13a. The engaging holes 13b correspond to the second projections 12c of the coupler 12. While the coupler 12 and the arm portion 13 are fitted to the support shaft 7a, the second projections 12c are fitted in the engaging holes 13b.

As shown in FIGS. 1(a) and 2, an engaging projection 14 is provided at the distal end of the arm portion 13. As shown in FIG. 5, the engaging projection 14 includes a shaft portion 14a, which extends toward the carrier 5 and is perpendicular to the arm portion 13, and an engaging portion 14b formed at the distal end of the shaft portion 14a. The engaging portion 14b has an outer diameter greater than that of the shaft portion 14a.

As shown in FIG. 5, the outer diameter of the engaging portion 14b is substantially the same as the distance between the first and second rail portions 31, 32 so that the engaging portion 14b can be fitted between the first and second rail portions 31, 32 of the engaging rail 30. The engaging portion 14b has a spherical portion 14c on its outer surface and the spherical portion 14c contacts the inner surfaces of the first and second rail portions 31, 32. The diameter of the engaging portion 14b of the engaging projection 14 is greater than the gap between the upper rims of the first and second rail portions 31, 32, that is, the gap formed by the engaging portion 34 of the engaging rail 30 so that the engaging portion 14b of the engaging projection 14 does not come off the space between the first and second rail portions 31, 32. The outer diameter of the shaft portion 14a is smaller than the gap formed by the engaging portion 34 of the engaging rail 30. The engaging portion 14b of the engaging projection 14 is retained between the fist and second rail portions 31, 32 and slides along the first and second rail portions 31, 32.

As described above, the vertex of the guide rail 4 curves in accordance with the curvature of the window glass 6 (see FIG. 1(b)). Therefore, when the carrier 5 moves along the guide rail 4, the carrier 5 moves between the position indicated by a solid line in FIG. 5 and the position indicated by a chain double-dashed line in FIG. 5 in a direction perpendicular to the second surface 2b of the base panel 2 (left and right direction as viewed in FIG. 5) corresponding to the curvature of the guide rail 4. The dimension of the first and second rail portions 31, 32 and the dimension of the engaging portion 14b in the direction perpendicular to the second surface 2b are set such that the carrier 5 is permitted to move in the direction perpendicular to the second surface 2b.

The power transmission arm 10 is mounted to the base panel 2 in the following manner.

First, the gear portion 11 is attached to the coupler 12. That is, as shown in FIGS. 6(a) and 6(b), the gear portion 11 is laid over the coupler 12, and the first projections 12a are inserted in the engaging holes 11b.

The coupler 12 is then attached to the arm support portion 7. That is, the support shaft 7a of the arm support portion 7 is inserted into the opening portion 12b of the coupler 12 to which the gear portion 11 is attached. At this time, the coupler 12 is rotated by substantially 90 degrees from the state shown in FIG. 6(a) such that the locking portion 7b of the arm support portion 7 can pass through the opening portion 12b. After the support shaft 7a is inserted in the opening portion 12b, the coupler 12 is rotated by 90 degrees to the position shown in FIG. 6(a). The meshing portion 11a of the gear portion 11 that is attached to the coupler 12 is then meshed with the pinion gear 3d.

Subsequently, in a state where the output shaft 3c of the window motor 3 is inserted in the insertion hole 15a of the retaining member 15, the retaining member 15 is secured to the base panel 2 with screws. Accordingly, the gear portion 11 and the coupler 12, which are overlapped with each other, are sandwiched between the support projections 2d of the base panel 2 and the retaining piece 15b of the retaining member 15.

After that, the arm portion 13 is attached to the arm support portion 7. That is, the support shaft 7a of the arm support portion 7 is inserted into the opening portion 13a of the arm portion 13. At this time, the arm portion 13 is rotated by substantially 90 degrees from the state shown in FIG. 6(a) such that the locking portion 7b of the arm support portion 7 can pass through the opening portion 13a. After the support shaft 7a is inserted into the opening portion 13a, the arm portion 13 is rotated by 90 degrees to the position shown in FIG. 6(a). The second projections 12c of the coupler 12 are then fitted in the engaging holes 13b. Accordingly, the coupler 12 and the arm portion 13 are coupled to each other such that the coupler 12 and the arm portion 13 integrally rotate about the support shaft 7a. Also, the locking portion 7b prevents the coupler 12 and the arm portion 13 from being detached from the base panel 2. The coupler 12 and the arm portion 13 may be coupled to each other in advance and then simultaneously attached to the arm support portion 7.

The operation of the door incorporated module 1 formed as described above will now be described.

As shown in FIG. 1(a), when rotation of the motor main body 3a is transmitted to the pinion gear 3d via the gear mechanism 3b, the power transmission arm 10 rotates clockwise or counterclockwise about the axis L2 of the arm support portion 7.

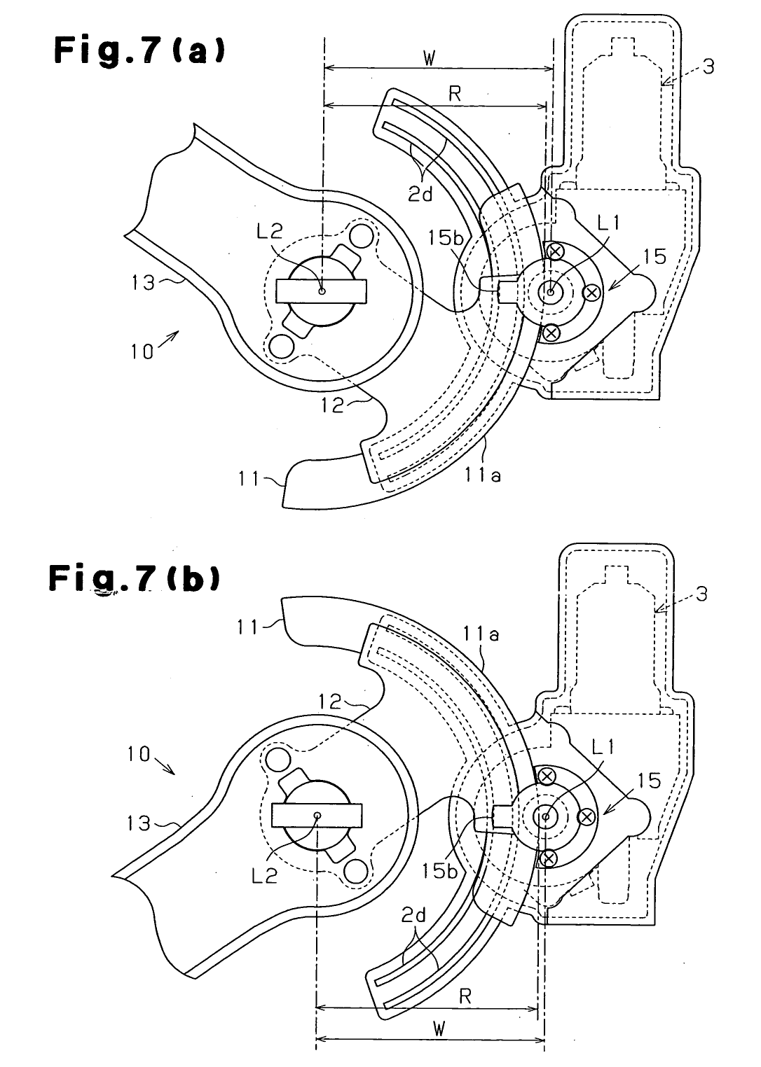

More specifically, as shown in FIG. 7(a), when the pinion gear 3d is rotated counterclockwise by the motor main body 3a, the gear portion 11 is rotated clockwise. Then, the distal end of the arm portion 13 is rotated upward as shown in FIG. 1(a) and the carrier 5 moves upward along the guide rail 4. Accordingly, the window glass 6 moves with the carrier 5 in the direction to close the window.

Contrarily, as shown in FIG. 7(b), when the pinion gear 3d is rotated clockwise by the motor main body 3a, the gear portion 11 is rotated counterclockwise. Then, the distal end of the arm portion 13 is rotated downward as shown in FIG. 1(a) and the carrier 5 moves downward along the guide rail 4. Accordingly, the window glass 6 moves with the carrier 5 in the direction to open the window.

The carrier 5 is supported by the guide rail 4 at three portions, which are the first to third guided portions 23 to 25. Therefore, the carrier 5 cannot rotate with respect to the guide rail 4. The window glass 6 is secured to the carrier 5 at two portions and cannot rotate with respect to the guide rail 4.

When the power transmission arm 10 rotates, the engaging portion 14b of the engaging projection 14 located at the second end 10b of the power transmission arm 10 slides with respect to the engaging rail 30 of the carrier 5.

When the carrier 5 moves along the guide rail 4, the distance between the carrier 5 and the second surface 2b of the base panel 2 changes in accordance with the curvature of the vertex of the guide rail 4. On the other hand, the engaging portion 14b located at the second end 10b of the power transmission arm 10 moves within a plane that is parallel to the second surface 2b of the base panel 2. The distance between the carrier 5 and the second end 10b of the power transmission arm 10 is smaller when the carrier 5 and the power transmission arm 10 are located at the position indicated by a solid line shown in FIG. 1(a) than the positions indicated by chain double-dashed lines in FIG. 1(a).

As shown in FIG. 5, in the first embodiment, the dimension of the first and second rail portions 31, 32 and the dimension of the engaging portion 14b of the engaging projection 14 in the direction perpendicular to the second surface 2b are set such that the carrier 5 is permitted to move in the direction perpendicular to the second surface 2b. Therefore, when the carrier 5 moves along the guide rail 4 in accordance with the rotation of the power transmission arm 10, the power transmission arm 10 and the carrier 5 do not receive undue force. The carrier 5 and the window glass 6 thus move smoothly.

The carrier 5 inclines in accordance with the curvature of the vertex of the guide rail 4 when moving along the guide rail 4. As shown in FIG. 5, the engaging portion 14b has the spherical portion 14c on its outer surface so that the engaging portion 14b is tiltable in the guide rail 4. Therefore, the carrier 5 is permitted to tilt with respect to the power transmission arm 10, and the carrier 5 and the window glass 6 move smoothly without causing the power transmission arm 10 and the carrier 5 to receive undue force. As shown in FIG. 5, the diameter of the engaging portion 14b of the engaging projection 14 is greater than the gap between the upper rims of the first and second rail portions 31, 32, that is, the gap formed by the engaging portion 34 of the engaging rail 30. Therefore, the engaging portion 14b of the engaging projection 14 is reliably prevented from coming off the engaging rail 30.

The thermal deformation of the door incorporated module 1 due to temperature change will now be described.

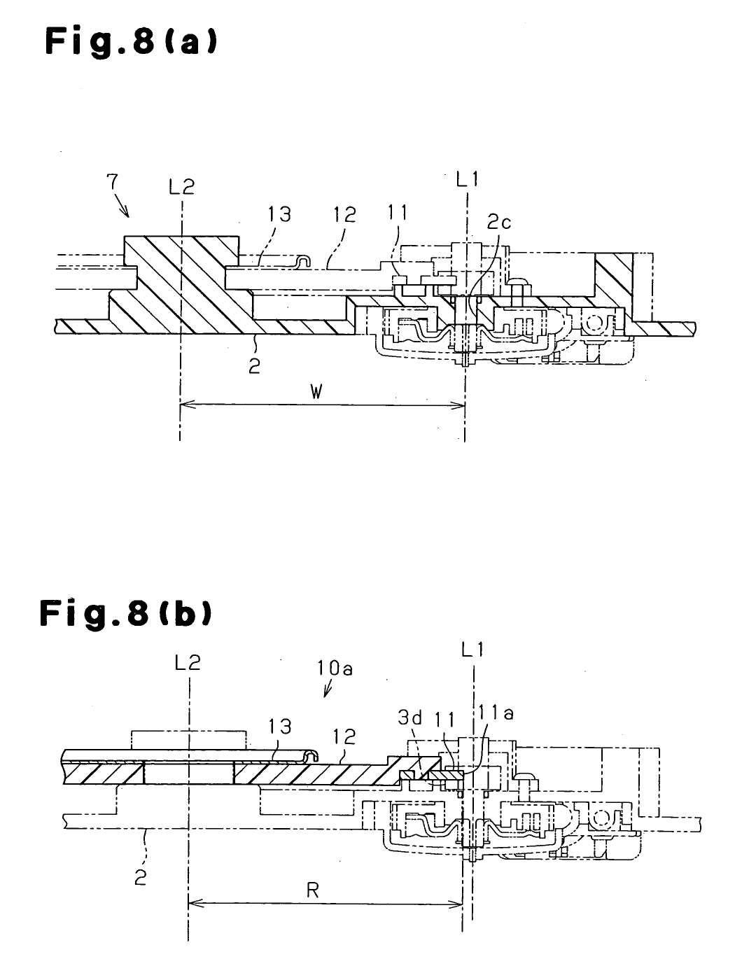

As shown in FIG. 8(a), the position of the axis L1 of the output shaft 3c is determined by the position of the insertion hole 2c formed in the base panel 2. The position of the rotational axis of the power transmission arm 10 is determined by the position of the axis L2 of the arm support portion 7 formed on the base panel 2. FIG. 8(a) shows the distance between the axes L1, L2, or the distance W between the axis of the insertion hole 2c formed in the base panel 2 and the axis of the arm support portion 7. FIG. 8(b) shows the length of the power transmission arm 10 between the axes L1, L2, or the distance R between the rotational axis of the power transmission arm 10 and the meshing portion 11a of the gear portion 11.

For example, when the base panel 2 undergoes thermal expansion due to temperature increase, the distance W is increased. The coupler 12, which is formed of resin having the same coefficient of linear expansion as resin forming the base panel 2, also undergoes thermal expansion, which increases the distance R. When the distance W is increased, or when the axis L1 moves apart from the axis L2, the output shaft 3c and the pinion gear 3d move apart from the arm support portion 7. On the other hand, the distance R is increased in accordance with the increase of the distance W. In other words, the meshing portion 11a of the gear portion 11 moves apart from the arm support portion 7.

That is, even if the pinion gear 3d moves apart from the arm support portion 7 by the thermal expansion of the resin material, the meshing portion 11a moves apart from the arm support portion 7 accordingly. Therefore, the relative position between the meshing portion 11a and the pinion gear 3d does not change significantly and the engagement between the meshing portion 11a and the pinion gear 3d is reliably maintained.

If the coupler 12 is made of a material, such as metal, the amount of deformation of which due to the temperature increase is relatively smaller than the resin material, the distance R does not increase adequately compared to the increase of the distance W. In this case, the pinion gear 3d separates from the meshing portion 11a. The deterioration of the engagement between the pinion gear 3d and the meshing portion 11a causes a backlash, or disengagement between the pinion gear 3d and the meshing portion 11a. However, in the first embodiment, the power transmission arm 10 has, between the axes L1, L2, the coupler 12 formed of resin material having the same coefficient of linear expansion as the resin material forming the base panel 2. Therefore, the engagement between the pinion gear 3d and the meshing portion 11a is reliably maintained.

This embodiment provides the following advantages.

In the first embodiment, the coupler 12, which forms part of the power transmission arm 10, is formed of material having the same coefficient of linear expansion as the material forming the base panel 2. This reduces the problems caused by the temperature change such as generation of noise due to the deterioration of engagement between the pinion gear 3d and the meshing portion 11a of the gear portion 11.

In the first embodiment, the coupler 12 is made of material that is the same as the base panel 2. More specifically, the coupler 12 is made of resin material that is the same as the base panel 2. Therefore, the deformation amount of the coupler 12 and that of the base panel 2 due to the temperature change are reliably prevented from deviating from each other. This effectively suppresses deterioration of engagement between the pinion gear 3d and the gear portion 11.

In the first embodiment, the guide rail 4 is located on the base panel 2. The carrier 5, which supports the window glass 6, is guided along the guide rail 4. This structure simplifies the structure for guiding the movement of the window glass 6, and reduces the number of parts and weight.

In the first embodiment, since the gear portion 11, which meshes with the pinion gear 3d, is made of metal, wear of the portion to be meshed with the pinion gear 3d is suppressed. The coupler 12 occupies most of the section of the power transmission arm 10 between the axes L1, L2, and the portion occupied by the metal gear portion 11 is small. The coupler 12, which is made of resin, extends to the vicinity of the meshing portion 11a, which meshes with the pinion gear 3d. Therefore, the deformation amount of the base panel 2 and that of the power transmission arm 10 due to the temperature change are more effectively suppressed from deviating from each other. Since the arm portion 13 is made of metal, the strength required for vertically moving the window glass 6 is easily applied to the power transmission arm 10.

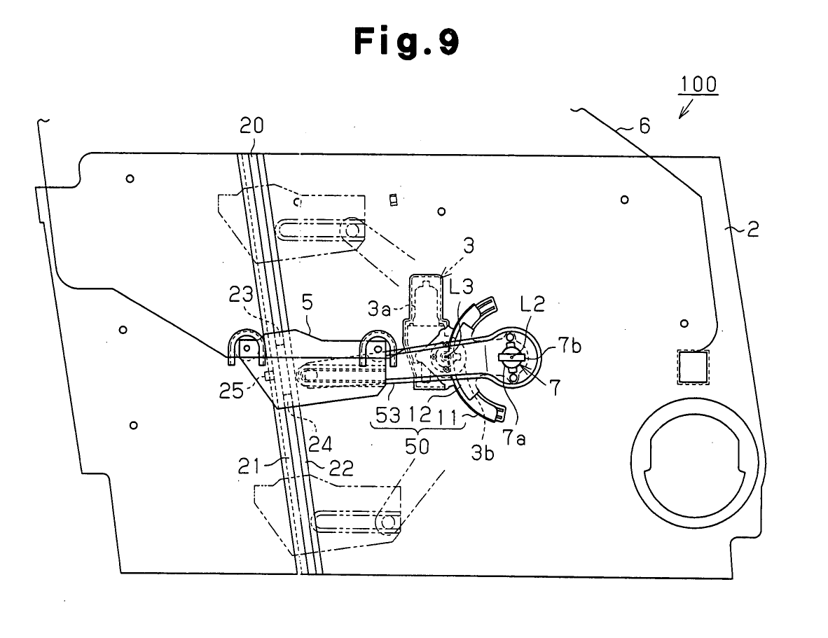

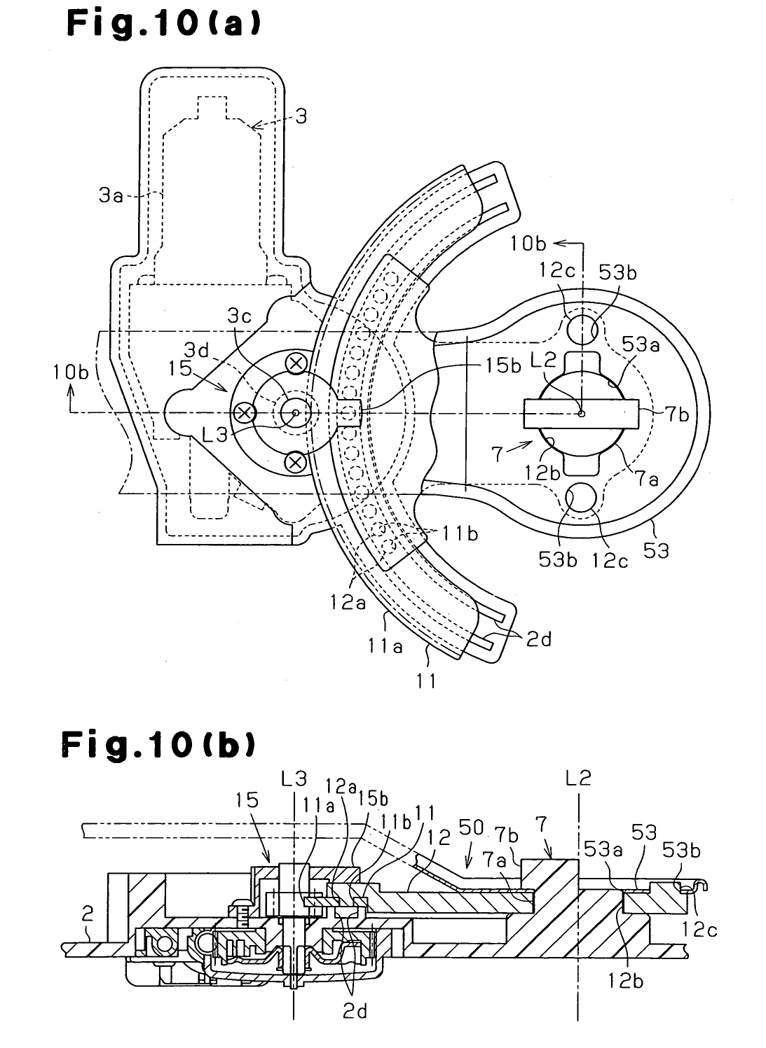

A second embodiment of the present invention will now be described with reference to FIGS. 9 to 10(b). The differences from the first embodiment of FIGS. 1 to 8(b) will mainly discussed below.

As shown in FIGS. 9 to 10(b), in a door incorporated module 100 according to the second embodiment, a mechanism for transmitting the power of the window motor 3 to the carrier 5 slightly differs from that of the first embodiment. That is, in the second embodiment, the window motor 3 is located between the distal end of an arm portion 53 of a power transmission arm 50 and the arm support portion 7. Therefore, the coupler 12 of the power transmission arm 50 and the gear portion 11 are located on the same side as the arm portion 53 with respect to the arm support portion 7. The axis L3 of the output shaft 3c of the window motor 3 is located between the axis L2 of the arm support portion 7 and the distal end of the arm portion 53.

As shown in FIG. 10(a), an opening portion 53a and engaging holes 53b, which are the same as the opening portion 13a and the engaging holes 13b of the arm portion 13, are formed at the proximal end of the arm portion 53. As shown in FIG. 10(b), the gear portion 11 and the coupler 12 overlap with each other and are sandwiched between the support projections 2d on the base panel 2 and the retaining piece 15b of the retaining member 15. The coupler 12 and the arm portion 53 are coupled to each other such that the coupler 12 and the arm portion 53 integrally rotate about the arm support portion 7. The part of the arm portion 53 between the arm support portion 7 and the output shaft 3c is bent in a direction to separate from the base panel 2 such that the arm portion 53 does not interfere with the output shaft 3c and the retaining member 15.

As shown in FIG. 10(a), when rotation of the motor main body 3a is transmitted to the pinion gear 3d via the gear mechanism 3b, the power transmission arm 50 rotates clockwise or counterclockwise about the axis L2 of the arm support portion 7.

More specifically, when the pinion gear 3d rotates clockwise, the gear portion 11 meshed with the pinion gear 3d rotates counterclockwise. Since the gear portion 11 and the coupler 12 are engaged with each other such that the gear portion 11 and the coupler 12 can rotate integrally with each other, the coupler 12 rotates counterclockwise about the arm support portion 7 in accordance with the rotation of the gear portion 11. When the pinion gear 3d rotates clockwise, the gear portion 11 and the coupler 12 rotates counterclockwise about the arm support portion 7. The arm portion 53 rotates about the arm support portion 7 in the same direction as the gear portion 11 and the coupler 12.

The second embodiment provides the following advantages in addition to the advantages of the first embodiment.

The window motor 3 is located between the rotational axis of the arm portion 53 and the carrier 5. Therefore, the coupler 12 and the gear portion 11 are located on the same side as the arm portion 53 with respect to the arm support portion 7. Thus, the length of the power transmission arm 50 can be substantially shortened. This reduces the size of the mechanism for transmitting the power of the window motor 3 to the carrier 5.

The above embodiments may be modified as follows.

The coupler 12 need not be formed of material having the same coefficient of linear expansion as the resin material forming the base panel 2, but may be formed of material having a coefficient of linear expansion that is close to the resin material forming the base panel 2. The coupler may be made of resin or a material other than resin. Furthermore, the coupler 12 may be formed of material having a coefficient of linear expansion that is greater than that of the resin material forming the base panel 2. This is particularly effective when part of the section of the power transmission arm 10 (50) between the axis L1 (L3) and the axis L2 occupied by the metal gear portion 11 is relatively large. As described above, the material for forming the coupler 12 can be selected as required such that the relationship between the distance W shown in FIG. 8(a) and the distance R shown in FIG. 8(b) is maintained to be substantially constant regardless of the temperature change.

In each embodiment, the guide rail 4 is located on the base panel 2. The carrier 5, which supports the window glass 6, is guided along the guide rail 4. However, instead of this structure, the guide portion (guide rail 4) for guiding the movement of the carrier 5 may be omitted and a guide portion for guiding both sides of the window glass 6 may be provided.

The gear portion 11 need not be made of metal as long as the gear portion 11 is made of material that does not wear easily by the engagement with the pinion gear 3d. Further, the arm portion 13 (53) need not be made of metal as long as the arm portion 13 (53) is made of material having the strength necessary to move the window glass 6 vertically.

The coupler 12 may be molded such that the gear portion 11 is integrated with the coupler 12. During such molding, an insert molding is preferably used. In this case, the process for attaching the coupler 12 to the gear portion 11 is unnecessary.

The present examples and embodiments are to be considered as illustrative and not restrictive and the invention is not to be limited to the details given herein, but may be modified within the scope and equivalence of the appended claims.

1. A module for incorporation into a door for moving a window glass provided with the door, the module comprising:
a base panel made of resin;
a window motor attached to the base panel;
a gear, which is rotated by operation of the window motor;
a carrier for retaining the window glass; and
a power transmission arm, which is supported by the base panel to be rotatable about a predetermined rotational axis, wherein the power transmission arm has a first end, which is engaged with the gear, and a second end, which is coupled to the carrier, when the gear is rotated by the window motor, the power transmission arm is rotated about the rotational axis, the rotation of the power transmission arm moves the window glass, and the power transmission arm has a portion made of material having a coefficient of linear expansion that is substantially the same as or greater than the coefficient of linear expansion of the base panel between the first end and the rotational axis.

2. The module according to claim 1, wherein the portion of the power transmission arm is made of resin material.

3. The module according to claim 1, wherein the portion of the power transmission arm is made of the same resin material as the base panel.

4. The module according to claim 1, wherein the power transmission arm includes:
a gear portion, which is meshed with the gear;
an arm portion, which is supported by the base panel to be rotatable about the rotational axis, the arm portion having a distal end, which is coupled to the carrier; and
a coupler, which couples the gear portion to the arm portion such that the gear portion integrally rotates with the arm portion, the coupler being made of material having a coefficient of linear expansion that is substantially the same as or greater than the coefficient of linear expansion of the base panel.

5. The module according to claim 4, wherein the window motor is located between the rotational axis and the carrier.

6. The module according to claim 4, wherein the coupler extends from the rotational axis toward the gear, and the gear portion is located at the distal end of the coupler.

7. The module according to claim 6, wherein the gear portion is made of a metal material and includes a meshing portion, which is meshed with the gear, and the coupler extends to the vicinity of the meshing portion.

8. The module according to claim 6, wherein the coupler is molded such that the gear portion is integrated with the coupler.

9. The module according to claim 4, wherein a retaining member is attached to the base panel, and the joint between the gear portion and the coupler is sandwiched between the base panel and the retaining member.

10. The module according to claim 1, wherein the base panel is provided with a guide portion, which extends along the direction of movement of the window glass to guide the carrier.

11. A module for incorporation into a door for moving a window glass provided with the door, the module comprising:
a base panel made of resin;
a window motor attached to the base panel;
a gear, which is rotated by operation of the window motor;
a carrier for retaining the window glass;
a gear portion, which is meshed with the gear;
an arm portion, which is supported by the base panel to be rotatable about a predetermined rotational axis, the arm portion having a distal end, which is coupled to the carrier; and
a coupler, which couples the gear portion to the arm portion such that the gear portion integrally rotates with the arm portion, when the gear is rotated by the window motor, the gear portion, the coupler, and the arm portion are rotated about the rotational axis, the rotation of the gear portion, the coupler, and the arm portion moves the window glass, and the coupler is made of a material having a coefficient of linear expansion that is substantially the same as or greater than the coefficient of linear expansion of the base panel.

12. The module according to claim 11, wherein the coupler is made of a resin material.

13. The module according to claim 11, wherein the coupler is made of a resin material that is the same as the resin material of the base panel.

14. The module according to claim 11, wherein the window motor is located between the rotational axis and the carrier.

15. The module according to claim 11, wherein the coupler extends from the rotational axis toward the gear, and the gear portion is located at the distal end of the coupler.

16. The module according to claim 15, wherein the gear portion is made of a metal material and has a meshing portion, which is meshed with the gear, and the coupler extends to the vicinity of the meshing portion.

17. The module according to claim 15, wherein the coupler is molded such that the gear portion is integrated with the coupler.

18. The module according to claim 11, wherein a retaining member is attached to the base panel, and the joint between the gear portion and the coupler is sandwiched between the base panel and the retaining member.

19. The module according to claim 11, wherein the base panel is provided with a guide portion, which extends along the direction of movement of the window glass to guide the carrier.
